(19) United States
(12) Patent Application Publication
(10) Pub. No.: US 2025/0387285 A1
(43) Pub. Date: Dec. 25, 2025

(54) DEVICE FOR POSITIONING A SUBJECT'S SHOULDERS DURING A MASSAGE

(71) Applicant: Amanda Rose DeYulis, Ebensburg, PA (US)

(72) Inventor: Amanda Rose DeYulis, Ebensburg, PA (US)

(21) Appl. No.: 18/748,911

(22) Filed: Jun. 20, 2024

(51) Int. Cl. A61H 1/02; A61G 13/00

(52) U.S. Cl. CPC A61H 1/0281; A61H 1/0222; A61G 13/009; A61H 2201/0138; A61H 2201/1607; A61H 2201/1638; A61H 2201/1673; A61H 2203/0456

(57) ABSTRACT

A device attachable to a massage table and to the wrists or forearms of a subject positioned on the massage table. The device applies tension on the subject's arms to provide improved positioning of the subject during a massage. A system that includes the device and a support element attachable to the massage table and useful to support and position the subject's arms along their sides to apply a downward tension thereon, i.e., toward the subject's feet, or support and angle the subject's arms away from their sides to apply an outward tension thereon. The system may further include the massage table.

### FIELD OF INVENTION

This disclosure generally relates to attachments for a massage table, and more specifically to attachments for a massage table that connect at a subject's wrists and pull the subject's shoulders downward.

### BACKGROUND

Stress often causes a subject to change their breathing patterns, leading to strain and tension in the muscles of the mid-back and shoulders. This strain can cause a subject's shoulders to hunch upward, leading to pain throughout the mid-back and shoulders. Another source of pain in the mid-back and shoulders is extended use of electronics and time spent sitting, which leads to misalignment of a subject's head with the vertical axis of their body. This imbalance eventually causes further misalignments in the body such as in the shoulders with increased thoracic kyphosis, an imbalance characterized by forward bending of the neck/upper back and rounding of the shoulders.

Postures involving rounded or hunched shoulders eventually lead to a tightening of the pectoral muscles on the front of the chest along with a lengthening and dysfunction of the rotator cuff muscles that wrap around and help provide stability to the shoulders and the upper back musculature (primarily mid/lower traps and rhomboids). As a consequence, the muscles of the upper back and neck are lengthened, become weak, and will feel tight. Massage to release this tightness, typically massage of the shoulders of a subject sitting or face down on a massage table, does not address the underlying issue of the lengthened mid/lower traps and rhomboids, and often works to further lengthen the mid/lower traps and rhomboids, thus worsening the misalignment.

### BRIEF SUMMARY

The devices, systems, and methods of the present disclosure solve many of the aforementioned problems by providing attachments for a massage table, and massage tables comprising those attachments, that pull a subject's arms downward toward their feet or outward away from the body. In this way, the massage may focus on releasing the tension in the pectoral muscles on the front of the chest without further lengthening of the mid/lower traps and rhomboids.

Thus, according to its major aspects and briefly stated, the present disclosure relates to a device for applying traction to a subject's arms (i.e., downward or outward tension). The device generally comprises at least a strap formed of a non-stretchable material and having an adjustable length, a first attachment element at a distal end of the strap, and a second attachment element connectable to a proximal end of the strap. The first attachment element is configured for connection to a massage table, and the second attachment element is configured for connection to a wrist or forearm of the subject.

According to aspects of the device, the first attachment element may be configured for releasable or non-releasable attachment to an underside of the massage table. Further, the second attachment element may comprise an open-ended cuff configured to be securable about the wrist or forearm of the subject via a hook and loop closure system, wherein the proximal end of the strap may be releasably attachable or non-releasably attached to the cuff, such as via a hook and ring, hook and loop closure, or swivel attachment.

According to aspects of the device, the massage table may comprise arm rests configured to support arms of the subject, wherein the arm rests are connected along longitudinal sides of the massage table proximate an end of the massage table that is configured to support a head of the subject. In this arrangement, the first attachment element may be configured for attachment to an underside of the arm rests proximate a distal end thereof.

According to further aspects, the device may be part of a system that comprises a support element configured to support an arm of the subject, wherein the support element is attachable to a longitudinal side of the massage table proximate an end of the massage table that is configured to support a head of the subject. The support element may be positionable parallel with a top surface of the massage table or 0.5 inches to 4.0 inches below the top surface of the massage table. The support element may comprise a proximal end and a distal end, wherein the proximate end may be rotatably attachable to the massage table. Further, the support element may comprise a guide proximate the distal end thereof, wherein the guide may be configured to position the strap to provide an outward force on the second attachment element when attached to the subject's wrist or forearm, and thus a downward or outward tension on the subject's arms.

According to aspects of the system comprising the device and the support element, the support element may comprise a longitudinal track on a top surface thereof, wherein the track may be configured to accept a bearing on the second attachment element of the device such that when the bearing of the second attachment element is connected within the track of the support element, the second attachment element may be moveable within the track. Further, the second attachment element of the device may be locked at any desired position within the track of the support element.

According to its major aspects, and briefly stated, the present disclosure also relates to a system for applying traction to a subject's arms. The system generally comprises a massage table having a tabletop with a top surface, a bottom surface opposite the top surface, a first end configured to support a subject's head, and a second end opposite the first end; and two devices for applying traction to the subject's arms, each device comprising: a strap formed of a non-stretchable material, wherein a length of the strap is adjustable, a first attachment element at a distal end of the strap, and a second attachment element connectable to a proximal end of the strap. The first attachment element is configured for connection to the massage table, and the second attachment element is configured for connection to a wrist or forearm of the subject.

According to aspects of the system, the first attachment element of the device may be configured for non-releasable or releasable attachment to the bottom surface of the massage table. Further, the second attachment element of the device may comprise an open-ended cuff securable about the wrist or forearm of the subject via a hook and loop closure system, wherein the proximal end of the strap may be releasably attachable or non-releasably attached to the cuff via a swivel attachment.

According to aspects, the system may further comprise a support element configured to support an arm of the subject, wherein the support element is attachable to a longitudinal side of the massage table proximate the first end thereof. The support element may be positionable parallel with the top surface of the massage table or 0.5 inches to 3.0 inches below the top surface of the massage table. The support element may be rotatable about a proximate end thereof such that a distal end thereof is angled away from the massage table, wherein the support element may comprise a guide proximate the distal end thereof, the guide configured to position the strap to provide an outward force on the second attachment element when attached to the subject's wrist or forearm.

According to aspects of the system, the support element may comprise a longitudinal track on a top surface thereof, the track configured to accept a bearing on the second attachment element, wherein the second attachment element is moveable within the track. The second attachment element may be locked at a position within the track.

According to aspects of the system, the first attachment element may be configured for attachment to an underside of the support element proximate a distal end of the support element.

### BRIEF DESCRIPTION OF THE DRAWINGS

Aspects, features, benefits, and advantages of the embodiments herein will be apparent with regard to the following description, appended claims, and accompanying drawings. In the following figures, like numerals represent like features in the various views. It is to be noted that features and components in these drawings, illustrating the views of embodiments of the presently disclosed invention, unless stated to be otherwise, are not necessarily drawn to scale. The present invention described herein may be better understood by reference to the accompanying drawing sheets, in which:

FIG. 1 illustrates a conventional massage table and typical arm positioning for a subject receiving a massage.

FIG. 2A illustrates a subject with rounded shoulders (at right) and shows loss of height as compared to a subject not having rounded shoulders (at left).

FIG. 2B illustrates a subject displaying tension in their shoulders.

FIG. 3A illustrates a device according to aspects of the present disclosure, wherein a distal end of the device is attached to opposing sides of a standard massage table.

FIG. 3B illustrates use of the device shown in FIG. 3A on a subject positioned on a massage table, wherein a proximal end of the device is attached to the subject's wrists.

FIG. 4 illustrates connection of the distal end of the device to a bottom of a standard massage table according to aspects of the present disclosure.

FIG. 5A illustrates an alternative connection of the distal end of the device to the bottom of a standard massage table according to aspects of the present disclosure.

FIG. 5B illustrates another alternative connection of the distal end of the device to the bottom of a standard massage table according to aspects of the present disclosure.

FIG. 6A illustrates an alternative connection means of the proximal end of the device to forearms of a subject according to aspects of the present disclosure.

FIG. 6B illustrates attachment of a strap of the device to the proximal end thereof according to aspects of the present disclosure.

FIG. 6C illustrates an alternative attachment of the strap of the device to the proximal end thereof according to aspects of the present disclosure.

FIG. 7A illustrates arm supports according to aspects of the present disclosure attachable to a massage table.

FIG. 7B illustrates an alternative position of the arm supports of FIG. 7A according to aspects of the present disclosure.

FIG. 8 illustrates the arm supports of FIG. 7A rotated outward, and another device according to aspects of the present disclosure configured for attachment to the wrist(s) or forearm(s) of a subject positioned on a massage table.

FIG. 9 illustrates the arm supports of FIG. 7A rotated outward, and another device according to aspects of the present disclosure configured for attachment to the wrist(s) or forearm(s) of a subject positioned on a massage table.

### DETAILED DESCRIPTION

In the following description, the present invention is set forth in the context of various alternative embodiments and implementations of a device configured to position the shoulders of a subject during a massage. The device is attachable to a massage table and to the wrists or forearms of a subject positioned on the massage table. The device is configured to pull the arms of the subject downward toward their feet or outward away from their body. Such tension may provide improved positioning of the subject receiving the massage. The present invention is also set forth in the context of various alternative embodiments and implementations of a system comprising the device and a support element, wherein the support element is configured to support the subject's arms during the massage, and when used in combination with the device, assist in applying traction to the subject's arm(s). The present invention is also set forth in the context of various alternative embodiments and implementations of a massage table comprising the aforementioned devices, or devices and support elements.

### Definitions and Abbreviations

Various aspects of the devices and methods of use thereof disclosed herein may be illustrated by describing components that are coupled, attached, and/or joined together. As used herein, the terms “coupled,” “attached,” and/or “joined” are interchangeably used to indicate either a direct connection between two components or, where appropriate, an indirect connection to one another through intervening or intermediate components. In contrast, when a component is referred to as being “directly coupled”, “directly attached,” and/or “directly joined” to another component, there are no intervening elements shown in said examples.

Various aspects of the devices and methods of use thereof disclosed herein may be illustrated with reference to one or more exemplary implementations. As used herein, the term “exemplary” means “serving as an example, instance, or illustration,” and should not necessarily be construed as preferred or advantageous over other variations of the systems, devices, and methods disclosed herein. “Optional” or “optionally” means that the subsequently described component, event, or circumstance may or may not be included or occur, and the description encompasses instances where the component or event is included and instances where it is not.

Furthermore, throughout the specification, reference to “one embodiment,” “an embodiment,” or “some embodiments” means that a particular described feature, structure, or characteristic is included in at least one embodiment. Thus, appearances of the phrases “in one embodiment,” “in an embodiment,” or “in some embodiments” in various places throughout this specification are not necessarily all referring to the same embodiment. Those skilled in the art will recognize that the various embodiments can be practiced without one or more of the specific details or with other methods, components, materials, etc. In other instances, well-known structures, materials, or operations are not shown or not described in detail to avoid obscuring aspects of the embodiments.

Certain terminology is used in the following description for convenience only and is not limiting. The words “lower,” “upper,” “bottom,” “top,” “front,” “back,” “left,” “right” and “sides” designate directions in the drawings to which reference is made but are not limiting with respect to the orientation in which the various parts of the systems and devices disclosed herein may be used unless otherwise indicated.

It must also be noted that as used herein and in the appended claims, the singular forms “a,” “an,” and “the” include the plural reference unless the context clearly dictates otherwise. For example, reference to “an” attachment, “a” strap, or “the” device may include reference to one or more attachments, straps, or devices.

Unless defined otherwise, all technical and scientific terms used herein have the same meanings as commonly understood by one of ordinary skill in the art.

All numerical quantities stated herein are approximate, unless indicated otherwise, and are to be understood as being prefaced and modified in all instances by the term “about”. The numerical quantities disclosed herein are to be understood as not being strictly limited to the exact numerical values recited. Instead, unless indicated otherwise, each numerical value included in this disclosure is intended to mean both the recited value and a functionally equivalent range surrounding that value.

All numerical ranges recited herein include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value equal to or less than 10.

As generally used herein, the terms “include,” “includes,” and “including” are meant to be non-limiting. As generally used herein, the terms “have,” “has,” and “having” are meant to be non-limiting.

### Aspects and Embodiments of the Present Disclosure

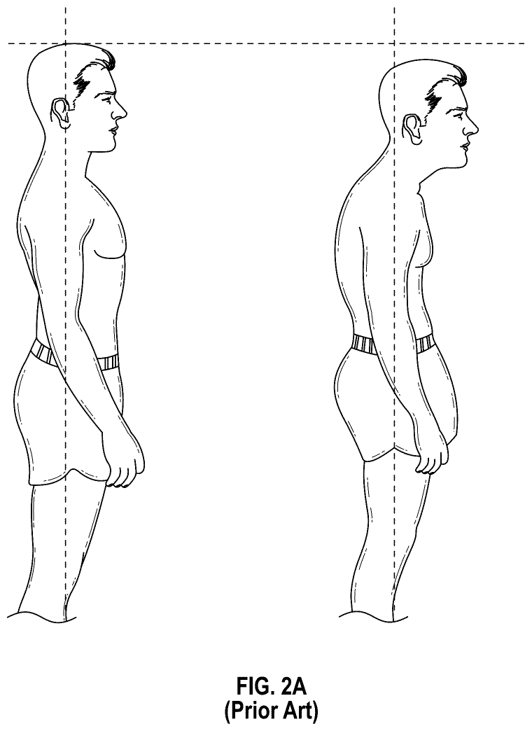

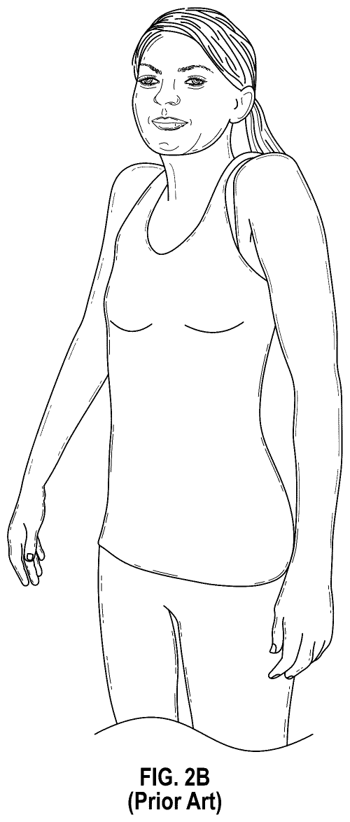

The devices and massage tables comprising those devices disclosed herein are intended to provide traction to a subject's arms to affect downward or outward tension on the subject's arms and thus shoulders. Rounded shoulders, generally found in conjunction with a forward head posture (see FIG. 2A at right), are often found in muscle builders who over-train the muscles of the chest and forego training the back to remain in balance. Rounded shoulders are more commonly seen in office workers who allow the shoulders to remain slumped and forward whilst working for long periods, particularly those who spend extended amounts of time in front of a computer. With the recent explosion of portable electronic devices, a forward leaning position of the head to view the device screen leads to further malalignments in the body, worsening the rounded shoulders and leading to thoracic kyphosis.

Stress is also the cause of bodily misalignments. For example, stress may cause a subject to change their breathing patterns, leading to strain and tension in the muscles of the mid-back and shoulders. This strain often causes a subject's shoulders to hunch upward (see FIG. 2B) leading to pain throughout the mid-back and shoulders.

As a result of these misaligned postures, a subject will experience pain and aching in the mid and upper back and shoulders. For example, rounded or hunched shoulders leads to a tightening of the chest muscles along with aching between the shoulder blades and throughout the upper back due to the dysfunction of the ligaments and muscles of the upper back. Such postures may also lead to other injuries for those training and/or playing sports. For example, the lack of proper stabilization around the shoulder girdle can lead to rotator cuff injuries.

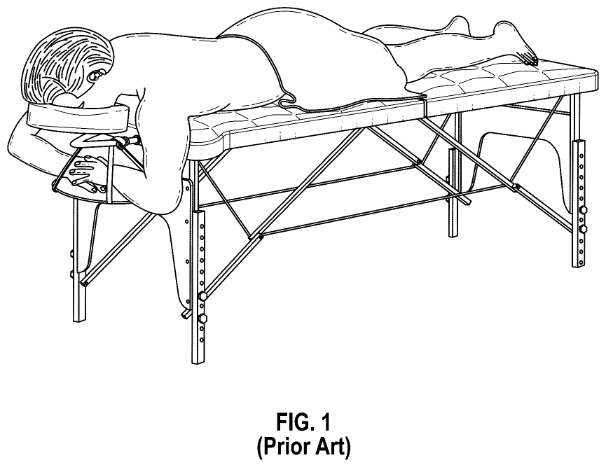

Typically, a subject having such pain may seek massage to help loosen the tension in the muscles of chest and relieve pain in the upper back and shoulders. Standard massage techniques, however, tend to address the muscles of the shoulders along the upper back. For example, as shown in FIG. 1, a standard massage position places the subject face down with their arms directly below their face. While providing temporary relief of the pain in the upper back and shoulders, such a position often leads to further lengthening of the muscles along the upper back and worsening of the imbalance over time. The devices of the present disclosure address many of the aforementioned problems by providing attachments for a massage table, and massage tables comprising those attachments, that pull a subject's arms downward toward their feet or outward away from their body. In this way, the massage may focus on releasing the tension in the pectoral muscles on the front of the chest without further lengthening of the mid/lower traps and rhomboids of the shoulders and upper back.

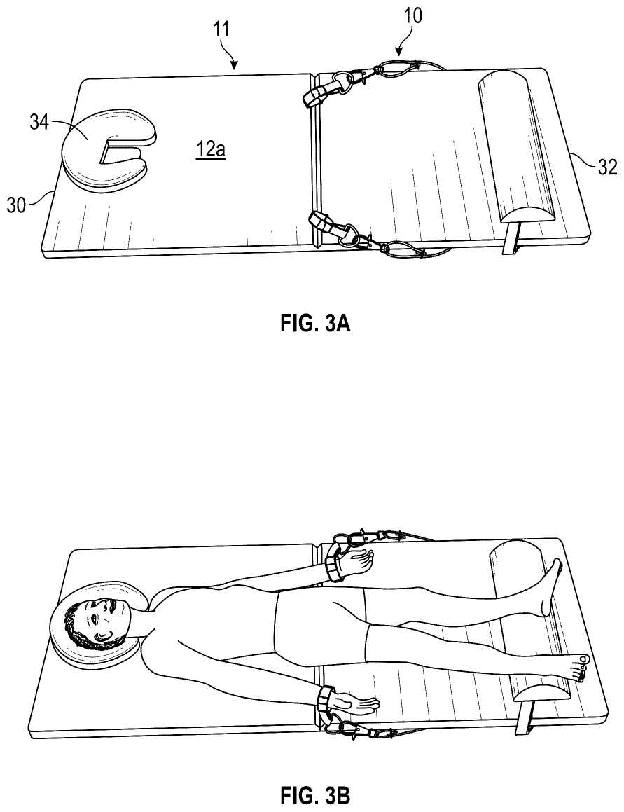

With reference to FIGS. 3A-6C, a device 10 for applying traction to a subject's arms is shown attached along each of the longitudinal sides of a massage table 11. As illustrated, a typical massage table 11 includes a top end 30 configured to provide support for the head of a subject receiving a massage (e.g., a pillow 34 on top surface 12a of the table 11) and a bottom end 32. A distal end of the device 10 is attachable to the massage table 11 and a proximal end of the device is attachable to the wrist or forearm of a subject about to receive a massage. In use, a length of the device 10 is adjusted to provide tension on the subject's arms and shoulders (i.e., downward toward the subject's feet or outward away from the subject's body).

The device 10 includes a strap 14 formed of a length of non-stretchable material or webbing. The length of the strap may be adjustable, such as via a triglide 20a or velcro 20b. For example, the strap 14 may comprise a webbing that is looped through an acetal standard triglide 20a such that sliding the triglide up/down along the webbing adjusts the length of the strap 14. As another example, the strap 14 may comprise two separate portions of webbing that are connected at a region substantially toward a middle of the strap 14. In this configuration, a middle end of a first portion may include a ring (e.g., d-ring, square ring, etc.) and a middle end of a second portion may include lengths of hook and loop closure material attached thereon (i.e., hook material and loop material such as Velcro™ attached along the same side of the webbing and spaced apart from each other). Passing the middle end of the second portion through the ring (d-ring, square ring, etc.) at the middle end of the first portion allows the length of the strap to be adjusted and secured at a desired length by folding that end over itself so that the hook and loop regions contact each other and secure the strap.

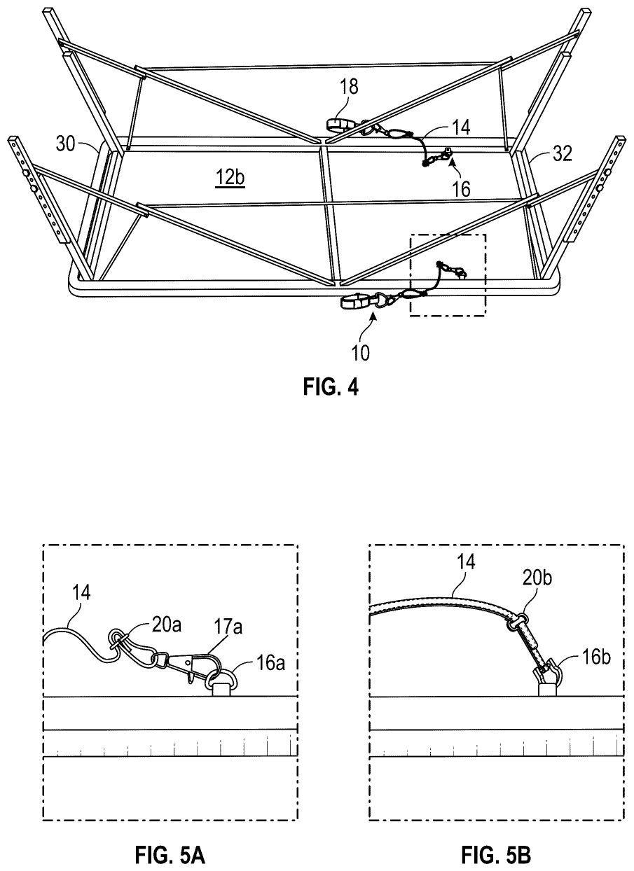

Attached on a distal end of the strap 14 is a first attachment element 16 configured to provide connection of the device 10 to the massage table 11. The strap 14 of the device 10 may be non-releasably attached to the massage table 11, such as on an underside 12b of the massage table toward the bottom end 32 thereof as shown in FIG. 4. In this configuration, the first attachment element 16 may be a screw or other connection element (nail, glue, staple, etc.) that provides the non-releasable connection to the massage table 11. Alternatively, the distal end of the strap 14 may be releasably attached to the massage table 11. In this configuration, the first attachment element 16 may include a hook 17a that is attachable to a loop 16a on the massage table (see FIG. 5A), or vice versa. Alternatively, the first attachment element 16 may include hook and loop closure material 20b and the massage table 11 may include a loop 16b (see FIG. 5B), wherein the region of the strap that is the first attachment element comprising the hook and loop closure material may be passed through the loop 16b on the massage table and then folded over itself so that the hook and loop regions contact each other and secure the strap to the massage table.

A proximal end of the strap 14 is attachable to the second attachment element. The second attachment element is releasably connectable to the wrist or forearm of the subject receiving the massage. As shown in FIG. 4, the second attachment element may comprise an open-ended cuff 18 configured to be securable about the wrist of the subject via a hook and loop closure system such as Velcro™. An exemplary cuff comprises a body and a closure device carried on the body for closing the cuff in a loop around the wrist of the subject. While the closure device has been shown and described as a hook and loop closure system, such may be replaced in alternative embodiments by a button closure, a snap closure, loop closure, an adhesive closure, or a magnetic closure.

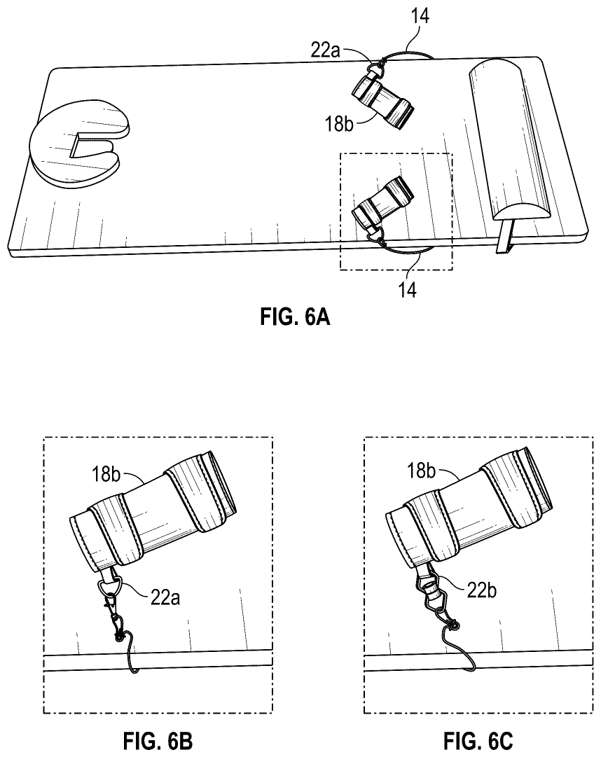

Alternatively, as shown in FIG. 6A-6C, the second attachment element may be a brace 18b configured to fit around the wrist and at least a portion of the forearm of the subject. The brace 18b may be an open-ended cuff having an extended longitudinal length (i.e., a length sufficient to cover more than the wrist of the subject) and securable about the wrist and forearm of the subject via a hook and loop closure system. An exemplary brace 18b comprises a body and a closure device carried on the body for closing the brace band in a loop around the wrist and at least a portion of the forearm of the subject. As above in relation to the cuff, while the closure device on the brace has been shown and described as a hook and loop closure system, such may be replaced in alternative embodiments by a button closure, a snap closure, loop closure, an adhesive closure, or a magnetic closure.

In either configuration, the second attachment element may be releasably or non-releasably connected to the proximal end of the strap 14. For example, the second attachment element may comprise a hook or ring 22a (d-ring, square-ring, etc.) that provides releasable connection to a corresponding clasp, hook, loop, etc. on the proximal end of the strap 14 (see FIG. 6B). In certain configurations, the second attachment element may comprise a swivel attachment 22b that provides free rotation between the second attachment element and the strap (see FIG. 6C).

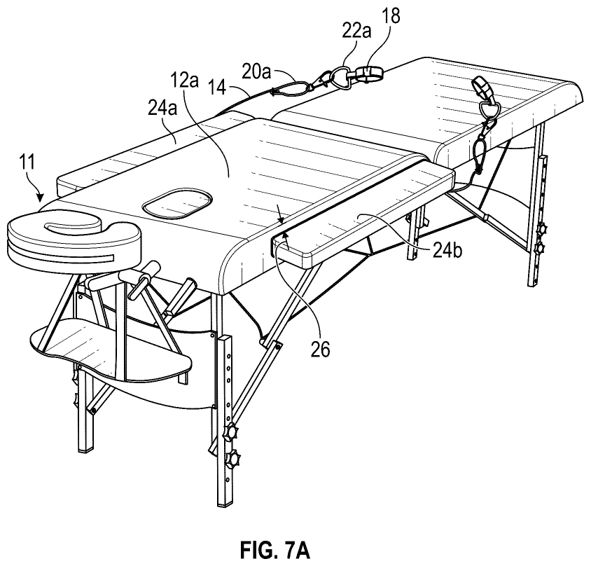

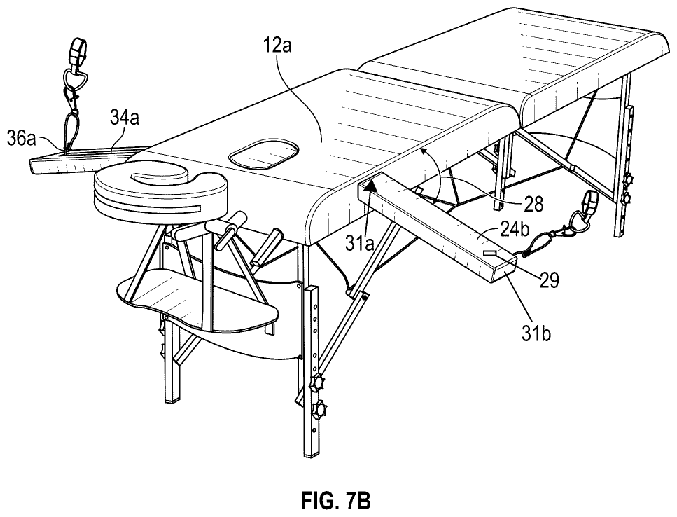

With reference to FIG. 7A-9, the device may be part of a system comprising a support element (24a, 24b), wherein the support element is configured to support an arm of the subject. The support element is attachable to a longitudinal side of the massage table 11 proximate a top end 30 thereof. For example, the support element (24a, 24b) may be attached to a longitudinal side of the massage table 11 or to a bottom surface 12b of the massage table 11. Once attached to the massage table 11, the support element (24a, 24b) may be positionable parallel to a top surface 12a of the massage table. Alternatively, the support element (24a, 24b) may be positioned below a top surface 12a of the massage table 11, such as spaced below the top surface by a distance 26. Exemplary distances 26 are 0.5 inches to 4.0 inches below the top surface of the massage table.

The support element (24a, 24b) may comprise a proximal end 31a and a distal end 31b, wherein the proximal end 31a is rotatably attachable to the massage table 11. Rotation of the support element (24a, 24b) about the proximal end 31a moves the distal end 31b outward by an angle 28 of up to 180° (i.e., angle 28 is 0° when the support element is parallel with the massage table 11 and the distal end is proximate the bottom end of the massage table, and angle 28 is 180° when the support element is parallel with the massage table 11 and the distal end of the support element is proximate the top end of the massage table). Further, the support element (24a, 24b) may comprise a guide 29 proximate the distal end thereof. The guide 29 may be configured to position the strap 14 of the device 10 on the top surface of the support element (24a, 24b), and thus provide an outward force on the second attachment element when attached to the subject's wrist or forearm (i.e., the guide may be a hook or loop configured to maintain the strap in position on a top surface of the support element so that the tension is in line with the longitudinal length of the support element).

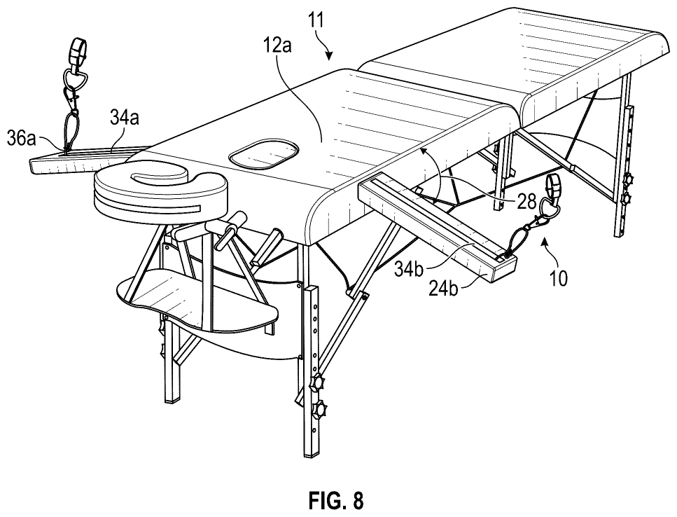

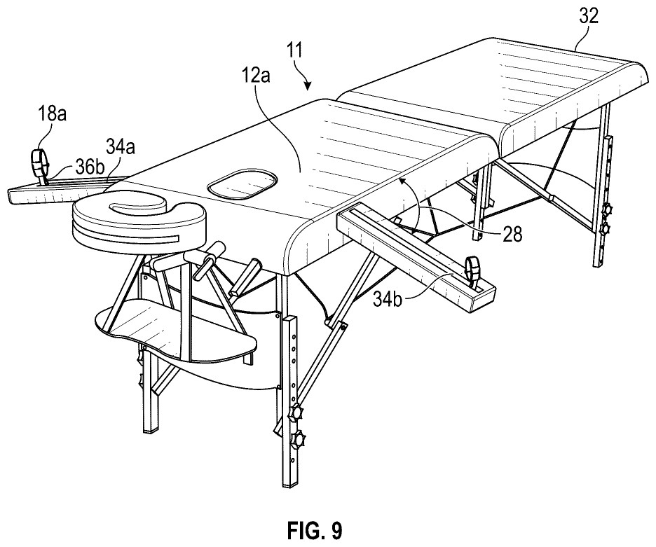

The support element (24a, 24b) may comprise a longitudinal track (34a, 34b) on a top surface thereof, wherein the track may be configured to accept a bearing 36a on the device 10 that connects the device 10 to the support element and allows the device to move within the track. The device 10 may be locked at a desired position within the track, typically a position that affords a downward or outward tension of the subject's arms and shoulders when the device is in use. For example, as shown in FIG. 8, the first attachment element 16 may be a bearing attached to a distal end of the device, wherein the bearing fits within the longitudinal track (34a, 34b). Alternatively, as shown in FIG. 9, the second attachment element 18 may comprise a bearing that fits within the longitudinal track (34a, 34b).

According to certain aspects, the system may comprise an arm (e.g., the support elements 24a, 24b) that lies along the longitudinal side of the massage table 11 proximate a top end 30 thereof and configured to support the subject's arm. The arm may be attached to a longitudinal side of the massage table 11 or to a bottom surface 12b of the massage table 11. Once attached to the massage table 11, the arm may be positionable parallel to a top surface 12a of the massage table. Alternatively, the arm may be positioned below a top surface 12a of the massage table 11, such as spaced below the top surface by a distance 26. Exemplary distances 26 are 0.5 inches to 4.0 inches below the top surface of the massage table. The arm may comprise a proximal end and a distal end (e.g., 31a and 31b, respectively), wherein the proximal end is rotatably attachable to the massage table 11. Rotation of the arm about the proximal end moves the distal end outward by an angle of up to 180° (e.g., angle 28). The arm comprises a longitudinal track (e.g., 34a, 34b) on a top surface thereof, wherein the track may be configured to accept a bearing 36b on a cuff or brace (e.g., 18 and 18b, respectively) that connects the cuff or brace to the arm and allows movement within the track. The cuff or brace is generally configured to attach to a wrist and/or forearm of the subject. To provide a downward or outward tension on the subject's arms and shoulders when the device is in use, the cuff or brace may be locked at a desired position within the track.

The devices and systems disclosed herein may be part of a larger massage table system that includes the support elements (24a, 24b). Further, one or more of the devices 10 and the support elements (24a, 24b), or system comprising an arm, may be part of a massage table system, i.e., system that include a massage table 11.

For example, the massage table system may comprise a massage table 11 having a tabletop with a top surface 12a, a bottom surface 12b opposite the top surface, a first end 30 configured to support a subject's head (e.g., pillow 34), and a second end 32 opposite the first end. The massage table system would typically include two devices 10 for applying traction to the subject's arms. As previously discussed, each device 10 may include a strap 14 formed of a non-stretchable material, wherein a length of the strap is adjustable, a first attachment element at a distal end of the strap 16, and a second attachment element 18 connectable to a proximal end of the strap. Each of the first and second attachment elements may be as described hereinabove.

In addition to the device(s) 10, the massage table system may further comprise a support element (24a, 24b) configured to support an arm of the subject, wherein the support element (24a, 24b) is attachable to a longitudinal side of the massage table 11 proximate the first end thereof 30. The support element (24a, 24b) may be positionable parallel with the top surface 12a of the massage table 11, or may be positioned 0.5 inches to 4.0 inches below the top surface 12a of the massage table 11. The support element may be rotatable about a proximate end 31a such that a distal end 31b is angled away from the massage table. Other aspects of the support element (24a, 24b) may be as described hereinabove.

The massage table system may comprise a massage table 11 having a tabletop with a top surface 12a, a bottom surface 12b opposite the top surface, a first end 30 configured to support a subject's head (e.g., pillow 34), and a second end 32 opposite the first end. The massage table may comprise arms (e.g., the support elements 24a, 24b) that lay along each of the longitudinal sides of the massage table 11 proximate a top end 30 thereof and configured to support the subject's arm. The arm may be attached to a longitudinal side of the massage table 11 or to a bottom surface 12b of the massage table 11. Once attached to the massage table 11, the arm may be positionable parallel to a top surface 12a of the massage table. Alternatively, the arm may be positioned below a top surface 12a of the massage table 11, such as spaced below the top surface by a distance 26. Exemplary distances 26 are 0.5 inches to 4.0 inches below the top surface of the massage table. The arm may comprise a proximal end and a distal end (e.g., 31a and 31b, respectively), wherein the proximal end is rotatably attachable to the massage table 11. Rotation of the arm about the proximal end moves the distal end outward by an angle of up to 180° (e.g., angle 28). The arm comprises a longitudinal track (e.g., 34a, 34b) on a top surface thereof, wherein the track is configured to accept a bearing 36b on a cuff or brace (e.g., 18 and 18b, respectively) that connects the cuff or brace to the arm and allows movement within the track. The cuff or brace is generally configured to attach to a wrist and/or forearm of the subject. To provide a downward or outward tension on the subject's arms and shoulders when the device is in use, the cuff or brace may be locked at a desired position within the track.

While particular embodiments have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications, and substitutions. This application including the appended claims is therefore intended to cover all such changes and modifications that are within the scope of this application.

What is claimed is:

1. A device for applying traction to a subject's arms, the device comprising:
a strap formed of a non-stretchable material, wherein a length of the strap is adjustable;
a first attachment element at a distal end of the strap; and
a second attachment element connectable to a proximal end of the strap,
wherein the first attachment element is configured for connection to a massage table, and the second attachment element is configured for connection to a wrist or forearm of the subject.

2. The device of claim 1, wherein the first attachment element is configured for releasable or non-releasable attachment to an underside of the massage table.

3. The device of claim 1, wherein the second attachment element comprises an open-ended cuff configured to be securable about the wrist or forearm of the subject via a hook and loop closure system.

4. The device of claim 3, wherein the proximal end of the strap is releasably attachable or non-releasably attached to the cuff via a swivel attachment.

5. The device of claim 1, comprising a support element configured to support an arm of the subject, wherein the support element is attachable to a longitudinal side of the massage table proximate an end of the massage table that is configured to support a head of the subject.

6. The device of claim 5, wherein the support element is positionable parallel with a top surface of the massage table or 0.5 inches to 4.0 inches below the top surface of the massage table.

7. The device of claim 5, wherein the support element comprises a proximal end and a distal end, wherein the proximal end is rotatably attachable to the massage table so that the distal end may extend away from the massage table.

8. The device of claim 7, wherein the support element comprises a guide proximate the distal end thereof, the guide configured to position the strap to provide an outward force on the second attachment element when attached to the subject's wrist or forearm.

9. The device of claim 7, wherein the support element comprises a longitudinal track on a top surface thereof, the track configured to accept a bearing on the second attachment element, wherein the second attachment element is moveable within the track.

10. The device of claim 9, wherein the second attachment element is lockable at a position within the track.

11. The device of claim 5, wherein the massage table comprises a support element configured to support an arm of the subject, wherein the support element is connected to a longitudinal side of the massage table proximate an end of the massage table that is configured to support a head of the subject, and wherein the first attachment element is configured for attachment to an underside of the support element proximate a distal end thereof.

12. A system for applying traction to a subject's arms, the system comprising:
a massage table comprising a tabletop with a top surface, a bottom surface opposite the top surface, a first end configured to support a subject's head, and a second end opposite the first end; and
two devices for applying traction to the subject's arms, each device comprising:
a strap formed of a non-stretchable material, wherein a length of the strap is adjustable,
a first attachment element at a distal end of the strap, and
a second attachment element connectable to a proximal end of the strap,
wherein the first attachment element is configured for connection to the massage table, and the second attachment element is configured for connection to a wrist or forearm of the subject.

13. The system of claim 12, wherein the first attachment element is configured for non-releasable or releasable attachment to the bottom surface of the massage table.

14. The system of claim 12, wherein the second attachment element comprises an open-ended cuff securable about the wrist or forearm of the subject via a hook and loop closure system.

15. The system of claim 14, wherein the proximal end of the strap is releasably attachable or non-releasably attached to the cuff via a swivel attachment.

16. The system of claim 1, comprising a support element configured to support an arm of the subject, wherein the support element is attachable to a longitudinal side of the massage table proximate the first end thereof.

17. The system of claim 16, wherein the support element is positionable parallel with the top surface of the massage table or 0.5 inches to 3.0 inches below the top surface of the massage table.

18. The system of claim 16, wherein the support element is rotatable about a proximal end thereof such that a distal end thereof is angled away from the massage table.

19. The system of claim 18, wherein the support element comprises a guide proximate the distal end thereof, the guide configured to position the strap to provide an outward force on the second attachment element when attached to the subject's wrist or forearm.

20. The system of claim 16, wherein the support element comprises a longitudinal track on a top surface thereof, the track configured to accept a bearing on the second attachment element, wherein the second attachment element is moveable within the track.

21. The system of claim 20, wherein the second attachment element is lockable at a position within the track.

22. The system of claim 16, wherein the first attachment element is configured for attachment to an underside of the support element proximate a distal end of the support element.
